(19) United States
(12) Patent Application Publication
(10) Pub. No.: US 2007/0211637 A1
(43) Pub. Date: Sep. 13, 2007

(54) Method of Optimizing Routing of Demands in a Network

(76) Inventor: Kevin Mitchell, Edinburgh (GB)

Correspondence Address: PERMAN & GREEN, 425 POST ROAD, FAIRFIELD, CT, 06824, US

(21) Appl. No.: 11/627,280

(22) Filed: Jan. 25, 2007

(30) Foreign Application Priority Data
Mar. 9, 2006 (GB) 0604746.8

(51) Int. Cl. H04J 3/14; H04L 12/56

(52) U.S. Cl. 370/238; 370/408

(57) ABSTRACT

The present invention relates to a method for optimization of demands in a packet switched communication network, especially, though not exclusively, for the optimization of demands in a Multi Protocol Label Switching (MPLS) packet switched communication network. The present invention provides a method to enable network nodes, such as routers to be clustered into components, with the components organised in a hierarchical fashion, and with the network “core” at the root of this hierarchy. Demands that originate or terminate at components outside the core, but that traverse the core, are temporarily replaced by demands that originate and terminate within the core component. Having optimized the resulting set of demands it is then shown how to use the solution to satisfy the original demands. Multi-access networks cause some complications, and these are taken into account. Also, further demand replacement methods have been developed that take into account complex access situations, In particular, as mentioned, the case has been considered, where there is an existing partitioning of the routers, e.g. into core and access routers, which needs to be respected.

The present invention relates to a method and apparatus for optimizing routing of demands in a network, especially, though not exclusively, for the optimization of demands in a packet switched communication network, such as a Multi Protocol Label Switching (MPLS) packet switched communication network.

### BACKGROUND OF THE INVENTION

MPLS is used in communication networks, specifically in Asynchronous Transfer Mode (ATM) and Internet Protocol (IP) networks to provide additional features, for example, precise control over routing, allowing for improved customer services. MPLS was originally developed to enhance performance and network scalability. A working group within the IETF (Internet Engineering Task Force) does standardization work on this topic, which is documented in “Requests for Comment” (RFCs).

In a packet switched network, as is well known, packets of data are routed over a plurality of links from a start point to a destination point. The links are coupled together by routers which receive the packets and decide on which link to send the packet depending on various factors, including, of course, the destination point of the packet. However, the router can also decide how to route the particular packet based on traffic on the links and, in some cases, on the priority of the particular packet of data. In an MPLS network, on the other hand, a particular Incoming packet is assigned a “label” by a Label Edge Router (LER) at the beginning of the packets route through the network or through a particular region of the network. The label assigned to the packet provides information as to a particular route the packet is to take through the network. Packets are thus forwarded along a Label Switched Path (LSP), from one Label Switching Router (LSR) to the next, with each LSR making forwarding decisions based solely on the contents of the label. At each “hop” the LSR strips off the existing label and applies a new label, which tells the next LSR how to forward the packet.

Since the traffic that flows along a label-switched path is defined by the label applied at the ingress node of the LSP, these paths can be treated as tunnels, tunnelling below normal IP routing and filtering mechanisms. When an LSP is used in this way it is referred to as an LSP tunnel.

LSP tunnels allow the implementation of a variety of policies related to network performance optimization. For example, LSP tunnels can be automatically or manually routed away from network failures, congestion, and bottlenecks. Furthermore, multiple parallel LSP tunnels can be established between two nodes, and traffic between the two nodes can be mapped onto the LSP tunnels according to local policy.

Traffic engineering is required to make efficient usage of available network resources. However, in order to be able to do this, an understanding of traffic patterns on the network, and of any problems that might exist, such as network failures, congestion, and bottlenecks, must be obtained. One way of doing so is to monitor links in the MPLS network. This ensures pre-defined Quality of Service (QoS) levels and Service Level Agreements (SLA's) are met.

A demand usually represents a requirement for a certain amount of bandwidth between an ingress node and an egress node, often with an associated traffic class, or QoS requirement. Demands arise from a variety of sources. A request to provision a high-bandwidth video link can be viewed as a demand. Another source of demands are aggregated “microflows” crossing a core network from an ingress to an egress, with a common traffic class, i.e. a demand might carry a single high-bandwidth flow, or be formed from a lot of smaller flows. A traffic class constrains the acceptable routes that can be used to service the demand, using parameters such as maximum delay or cost. In some cases a demand for bandwidth, with a certain QoS, will be sufficiently predictable over time that traffic can be assigned to MPLS paths, and then the best routes determined for these paths that minimizes congestion. As long as the variability in bandwidth requirements is not excessive, offline path placement, coupled with the use of on-line fine tuning to adjust the reservations at “runtime” can yield a useful network optimization strategy, for example as discussed in the white paper: “Auto-bandwidth allocator for MPLS traffic engineering”, Cisco. 2003. Offline and online demand optimization generally occurs for different reasons and at different time scales, each using different mechanisms.

ATM networks had previously been used within network cores, and offline tools had been developed to optimize the routing of paths through ATM network “clouds”. These tools were quickly adapted to support the offline optimization of bandwidth guaranteed LSPs through MPLS clouds. Given the small size of typical core networks this optimization problem was reasonably tractable. The main constraint was that demands must not be split. They represent a collection of aggregated flows and it is difficult to split these across multiple paths without introducing unnecessary packet reordering within the individual flows.

The need for service differential between flows has recently become increasingly important as operators struggle to find profitable revenue streams. However, there is a limit to how much service differential can be achieved. One method is to use MPLS to provide multiple paths across the network, and to then assign flows to paths based on their traffic class. However, this can introduce additional complexity into a part of the network that is already heavily stressed.

More recently, the MPLS boundary has been gradually moving outside the core into the access portion of networks, known as access networks. This allows packets to be classified and assigned to LSPs prior to reaching the core, using tunnelling to choose the desired path across the core and minimising the signalling and state that must be supported by the core routers. In more complex scenarios it also allows the operator to choose different paths across the access networks themselves.

This trend has a number of consequences for any offline optimization. The size of the MPLS cloud is no longer restricted to the size of the core network. This creates a serious scaling problem for any optimization tool (optimizer), requiring the development of techniques to decompose the problem into something more manageable. The traffic originating within the access layers will typically be less aggregated than that in the core, and so exhibit greater fluctuations. This makes it difficult to identify LSPs that are persistent and stable enough to be worth routing offline.

Systems such as those discussed in the whitepapers: “Traffic optimizer product overview”, Cplane 2003; and “IP/MPLSView: Integrated network planning, configuration management & performance management”, WANDL 2002; allow an operator to optimize MPLS demands across the core of a network. They assume a predefined partition of the network into access and core routers, so that the demands to be optimized are then restricted to the core. Other demands may originate in the access network, such as those In a Voice over IP (VoIP network). There are a number of reasons why the “access network” optimization problem should be treated differently to the equivalent core problem.

One reason is that globally optimizing a large number of demands, spanning many routers, is computationally very expensive. This cost increases rapidly as the number of demands and/or routers is increased. Decomposing the problem into a collection of simpler problems is essential if realistic optimization times are to be achieved.

A second reason is that many organisations use different groups of people to manage the core and access networks. Even if the demands could be routed across the whole cloud, it might not be possible to deploy such a solution because of these administrative divisions. A better approach might be to use the access demands to construct a set of requirements for core demands necessary to support this traffic. These requirements could then be passed to the group handling the optimization of the core of the network (the core group), who can optimize the placement of these demands using traditional or new optimization techniques. The group handling the optimization of the access portion of the network (the access group), would use the solutions to these requirements to build LSPs to support the original demands. The requirements projected onto the core from a set of access demands may be rather different in character to a traditional set of core demands, potentially requiring different core optimization tools.

Another reason is due to the fact that provisioning an LSP hop-by-hop across the whole route between ingress and egress may be inefficient. Each router along the way will need to process the signalling traffic necessary to keep the LSP alive, and to reserve state within the router. It may be more efficient to define a set of LSPs across the core, and then use these as tunnels for the permanent LSPs that originate in the access network. Only the access routers would then store state specific to the access LSPs.

Optimizing the placement of demands across a network is computationally expensive. There are two main approaches to tackling this problem, which is known in the art as a multi-commodity flow problem, an edge-based strategy and a path-based strategy, both of which are also known in the art.

In an edge-based strategy, a linear program attempts to compute the amount of each demand carried by each link in the network. In the worst case, with a full mesh of demands, and a highly connected network graph, there will be 0(n²) demands and 0(n²) edges. The paper “MPLS traffic engineering in OSPF networks—a combined approach”, by Köhler, S. and Binzenhöfer, A. published in Tech. Rep. 304, Institute of Computer Science, University of Würzburg, February 2003 contains five example topologies of increasing size. It can also be shown that computation times quickly increase as the network size grows. An edge-based strategy has another disadvantage when the demands have additional QoS constraints attached to them. The paths found by the optimizer may not satisfy the constraints, e.g. of delay or hop length, resulting in an invalid solution. Attempts to enforce these constraints during the optimization process quickly lead to intractable models, even for small networks. An edge-based approach is therefore most suited for demands with liberal QoS constraints, such as best-effort traffic.

Another approach may be to first identify a set of potential paths for every demand, each of which satisfies the QoS constraints. Then a linear program may be used to calculate how much of the demand should be carried by each path. If only a small number of paths are used for a demand, then the size of the optimization problem can be limited to something tractable. The downside is that the solution is only as good as the choice of paths. If the number of paths is increased, to increase the chance an optimal solution is found, then the optimization times grow very quickly, particularly for highly connected network graphs.

For demands with strict QoS properties, the best strategy may be to use a path-based approach and hope that the number of valid paths for each demand is fairly small. But as the network size Increases the stage is quickly reached where optimization times become intractable. The case where there are multiple paths through the access network also creates difficulties for the path-based approach. Using something like A*Prune, as disclosed in “A*prune: An algorithm for finding k shortest paths subject to multiple constraints, Liu, C. and Ramakrishnan, K. C. 2001, In INFOCOM. 743-749”, it may be found that most paths share a common sub-path across the core. In many cases more variability in the paths is required in order to find a good solution to the optimization problem.

In a typical backbone network there could be a hundred or more nodes. Even a single traffic class, with demands between each pair of devices, generates a problem that would be very expensive to optimize directly. It seems clear that there is a need to find apparatus and method(s) for simplifying the demand placement problem if problems of this scale, or larger, can be adequately tackled.

### BRIEF SUMMARY OF THE INVENTION

It is therefore an object of the present invention to provide a method for optimizing routing of demands in a network which overcomes, or at least mitigates, the disadvantages of the prior art.

Accordingly, the invention provides a method of optimizing routing of demands in a network comprising nodes interconnected by links, each demand comprising a source node, a destination node and at least one demand parameter requirement, the method comprising:
a) partitioning nodes and links of a network into a set of clusters of links and nodes;
b) imposing a hierarchical tree structure on the set of dusters such that any pair of dusters has a unique path between them via a closest common ancestor;
c) determining optimum paths for all demands such that the paths meet the at least one demand parameter requirement by processing the demands in each cluster only after all dusters lower in the same branch of the hierarchical tree structure have been processed, the processing for each duster comprising:
   i. splitting each demand into an intra-cluster demand in which the source and destination nodes are in the same cluster and, if appropriate, an inter-duster demand in which the source and destination nodes are in different dusters;
   ii. determining optimum paths for all intra-duster demands so as to meet the at least one demand parameter requirement; and
   iii. passing all inter-cluster demands upwards to the next cluster in the hierarchical tree structure to be processed as a demand therein.

In one embodiment, the method further comprises passing information relating to network costs of the paths that have already been optimized upwards to the next cluster in the hierarchical tree structure so that the network costs already used can be utilized when determining optimum paths for intra-cluster demands still to be optimized.

The network costs can comprise costs incurred with respect to a particular demand parameter requirement, such as a traffic class requirement, e.g. a maximum delay requirement.

The determination of optimum paths for all demands can include determining optimum paths based on at least one network parameter requirement, such as a traffic density requirement.

### BRIEF DESCRIPTION OF THE DRAWINGS

Several embodiments of the invention will now be more fully described, by way of example, with reference to the drawings, of which:

FIG. 1 shows a schematic diagram of an apparatus for optimizing routing of demands in a network according to a first embodiment of the present invention;

FIG. 2 shows a flow chart describing a method of operation of a network structure analyzer incorporated in the apparatus of FIG. 1;

FIG. 3 shows a schematic diagram of a network;

FIG. 4 shows a diagram illustrating the results of a bi-connected components analysis as performed on the network shown in FIG. 3;

FIG. 5 shows a diagram illustrating the results of applying tree merging rules to the results of FIG. 4;

FIG. 6 shows a diagram illustrating the results of imposing a hierarchical tree structure on the results of FIG. 5;

FIG. 7 shows a diagram illustrating a simple demand replacement and optimization example, according to a first embodiment of the present invention;

FIG. 8 shows the demand splitting process for an egress duster, according to a first embodiment of the present invention; and

FIG. 9 shows a flow diagram of a demand replacement and optimization operation of the apparatus of FIG. 1

### DETAILED DESCRIPTION

Thus, as mentioned above, it is desirable to be able to optimise routing of demands in a telecommunications network in order to increase the capacity of the network. The present invention, in a first embodiment, provides a method and apparatus for carrying out such an optimisation by analysing the network and virtually organizing the routers, or nodes, into clusters, with the clusters then being organised in a hierarchical fashion, with the network “central core” at the root of this hierarchy.

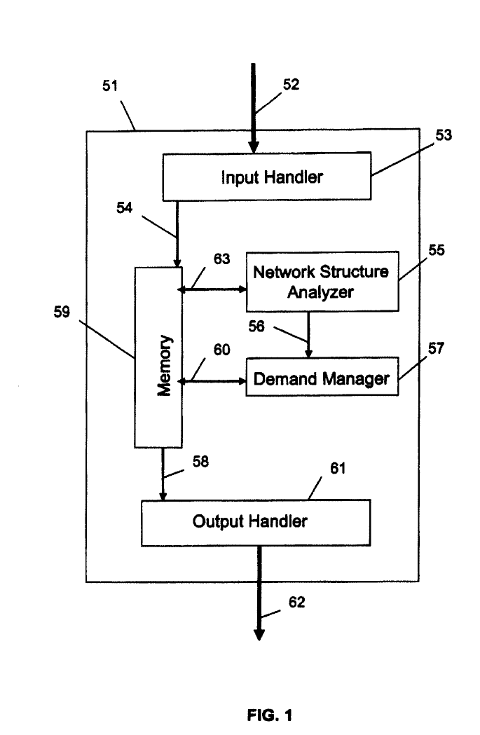

Thus, FIG. 1 is a schematic diagram showing the architecture of a demand optimizer according to a first embodiment of the present invention. The demand optimizer 51 includes an input handler 53, which receives, via input link 52, details of the network structure and demands to be optimized. The input handler 53 passes the network structure details and the demand to a memory 59 via link 54. A network structure analyser 55 is coupled to the memory 59 via two-way link 63 and performs an analysis of the network structure, as will be further described below. A demand manager 57 is also coupled to memory 59 via two-way link 60, and to the network structure analyzer 55 via link 56. An output handler 61 is coupled to the memory 59 via link 58 and allows external access to the results via output link 62. The output handler 61 may provide the results on a GUI (Graphical User Interface), for example. The demand optimizer 51 could be implemented on a Unix machine, but it should be clear to a person skilled in the art that it could be implemented in any other suitable manner. The input handler 53 may also take in user configuration inputs, which are discussed further below

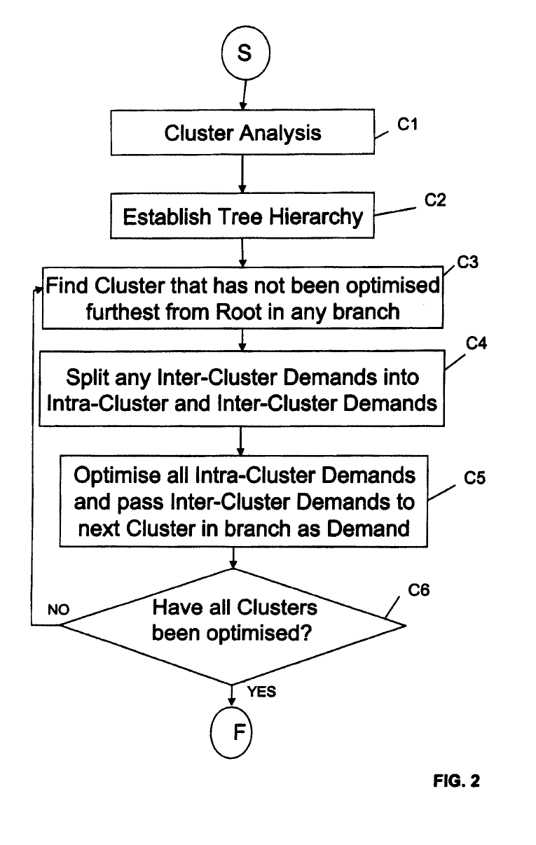

FIG. 2 shows a schematic flow chart describing the general operation of the network structure analyser incorporated in the demand optimizer of FIG. 1 starting at point “S” and ending at point “F”. Thus, In general, the network structure is first analysed to partition the nodes into clusters (see element C1), following which a tree hierarchy is imposed on the clusters in element C2. It will be apparent, as will be more fully described below, that in a hierarchical tree structure, there are a number of branches with each cluster in a branch being connected in the core direction to a single “parent” duster, that “parent cluster”, in turn being connected in the core direction to a further “grandparent” cluster (if required), all the way back to the core (or “root”) cluster itself. In order to optimise all the clusters, optimisation proceeds from descendent dusters towards ancestor clusters. A “descendent” cluster is taken to be the duster that is furthest away from the core duster in any particular tree. Thus, the youngest non-optimised duster is first determined (see element C3) and optimised, and then another youngest non-optimised duster is determined and optimised. In this way, no cluster is optimised until after all its “descendent” dusters have been optimised.

Optimisation of a cluster involves splitting any inter-cluster demands that have either a start point or a destination point in that cluster into a pair of demands of which one is an intra-duster demand (that has both the end points in that duster) and an inter-duster demand (see element C5). The intra-duster demands are optimised and the inter-duster demands are passed upwards in the tree hierarchy to the particular cluster's parent duster, where they are treated as demands in that cluster. A determination is then made in element C6 as to whether all dusters have been optimised. If so, the process ends at point “F”. If not, then the process moves back to element C3, where another youngest non-optimised cluster in a branch is found. Thus, the process will optimise all the dusters from the periphery of the hierarchical tree structure towards the core duster, until all clusters are optimised.

Thus, in order to decompose the network to partition the nodes into clusters, the network must be analysed. A duster is, generally, a group of closely connected nodes and the links between them, with the duster itself being loosely connected to another duster of closely connected nodes. Each duster will be joined with one or more connecting nodes, which connect that duster to another cluster, so that a connecting node may be considered to be part of both clusters. Of course, in some cases, a cluster may only have one or more connecting nodes.

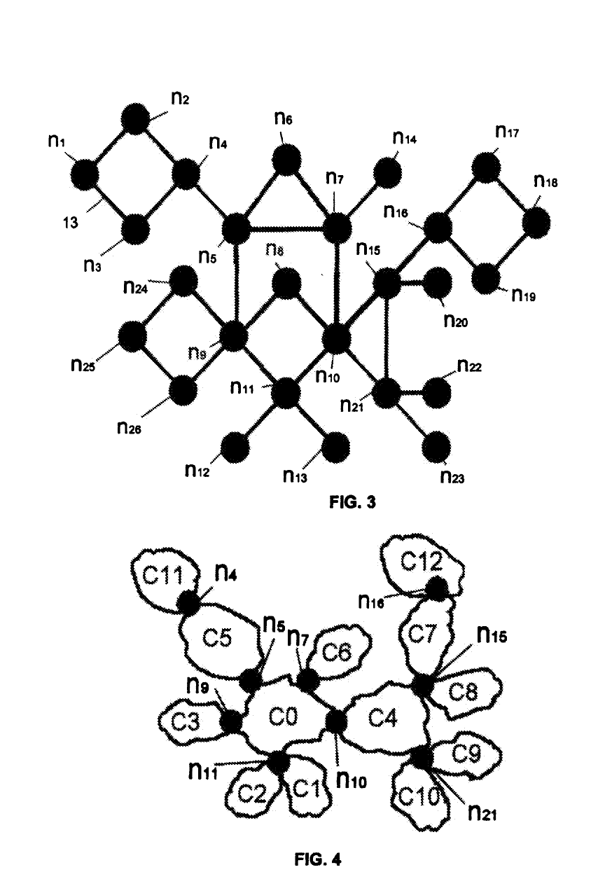

To better describe element C1 of FIG. 2, FIG. 3 shows a schematic diagram of a simple network having a plurality of nodes n₁, n₂, n₃, . . . n₂₆. The nodes n₁ . . . n₂₆ are connected by links 13 In various ways to form a network. As mentioned above, the network is first analysed to partition the nodes into clusters of nodes. Any type of suitable cluster analysis, may be used. For example, one known type of analysis that may be used is bi-connected component analysis. However, it will be clear to a person skilled in the art that any suitable duster analysis technique, such as Principal Components, could be used instead. FIG. 4 shows the results of a bi-connected components analysis, as performed on the network of FIG. 3.

In order to perform the bi-connected component analysis, the following rules have been used:
a node n in a connected network is a connection node if the deletion of node n from the network, along with the deletion of all links to node n, disconnects the network into two or more nonempty portions;
a network (portion) is bi-connected if, and only if, it contains no connection nodes;
A network portion is maximally bi-connected, if and only if, the network has no other bi-connected portion containing all the nodes and links of the maximal bi-connected network portion. A maximal bi-connected network portion is a bi-connected cluster;
two bi-connected clusters can have at most one node in common and this node is connecting node; and
nodes with links from more than one cluster are connection nodes.

After performing the bi-connected component analysis, the network is partitioned into resulting clusters, numbered C0, C1, C2 . . . C12 connected by connecting nodes as shown In FIG. 4. Thus, as shown in Table 1 each of the clusters contains some of the nodes from the network of FIG. 3 that are not connecting nodes, as well as the connecting nodes that form part of each of the dusters that they connect (the connecting nodes are shown partly outside each of the dusters that they connect, for ease of visibility), as follows:

TABLE 1
Results of the bi-connected component analysis

| Cluster | Contains nodes |
|---|---|
| C0 | {n₅, n₆, n₇, n₈, n₉, n₁₀, n₁₁} |
| C1 | {n₁₁, n₁₃} |
| C2 | {n₁₁, n₁₂} |
| C3 | {n₉, n₂₄, n₂₅, n₂₆} |
| C4 | {n₁₀, n₁₅, n₂₁} |
| C5 | {n₄, n₅} |
| C6 | {n₇, n₁₄} |
| C7 | {n₁₅, n₁₆,} |
| C8 | {n₁₅, n₂₀} |
| C9 | {n₂₁, n₂₂} |
| C10 | {n₂₁, n₂₃} |
| C11 | {n₁, n₂, n₃, n₄} |
| C12 | {n₁₆, n₁₇, n₁₈, n₁₉} |

For example, cluster C0 contains original nodes n₅, n₆, n₇, n₈, n₉, n₁₀ and n₁₁, whereas clusters C4 and C5 only have the connecting nodes n₁₀, n₁₅ and n₂₁, and n₄ and n₅, respectively. All nodes from the network of FIG. 3 are therefore either completely within a cluster or are a connecting node.

Although not necessary, it is preferable to simplify this duster structure further by finding dusters that can be merged together. It will be apparent that nodes in a tree structure are easy to handle as there is a unique path between any two nodes in a tree. Thus, placing demands would be trivial as there is no choice. Since a usual bi-connected component analysis will split trees into a hierarchy of clusters, it is not always efficient to have it split into a large number of small clusters. Therefore, it may be useful (efficient), although not necessary, to process these results further to look for clusters that have been generated from tree substructures and to merge these into larger structures. Alternatively, the other clustering techniques could be used that don't require such a further processing step. For example, the bi-connected component analysis may be changed so that it performed such merging as it went along. The first tree duster merging rule can be used repeatedly to merge sibling components.

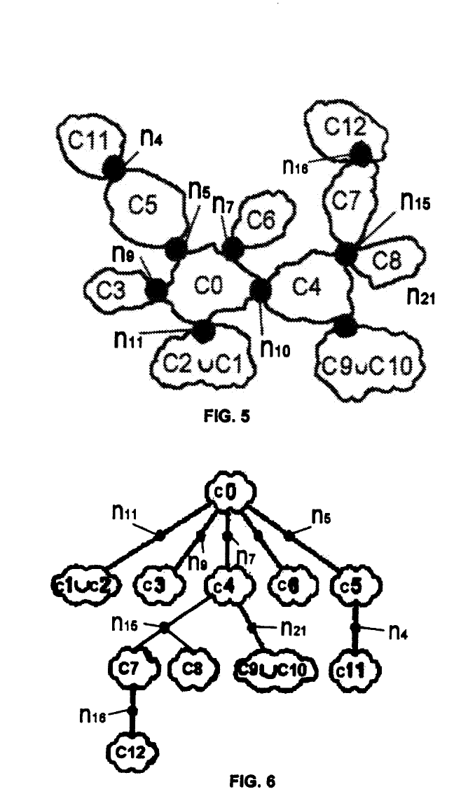

FIG. 5 shows a diagram illustrating the results of applying the tree merging rules to the previous results. In this figure, the notation “x∪y” has been used to denote the duster containing the union of clusters “x” and “y”. For example C7∪C8 illustrates the union of the dusters “C7” and “C8”.

The cluster diagram shown in FIG. 5 provides some simplification with respect to the node network of FIG. 3, but the core duster, i.e. the core of the network still needs to be identified (this relates to step C2 of FIG. 2). The core cluster can be determined in many different ways. Picking the largest duster, for example, including its connecting nodes, seems plausible, except that with a very large network, there may be more large nodes than the “true” core. Similarly choosing the cluster with the smallest maximum path length to all the other clusters seems reasonable, as it would tend to find the clusters in the “centre” of the tree. However, a network with many hops will tend to derail such an approach, since a cluster near the end of such a chain of clusters is more likely, potentially, to be incorrectly identified as the core cluster.

A more robust solution is to choose the cluster whose average path length to all the other dusters is minimised. The average path lengths for the example given with reference to FIG. 5 are presented in Table 2.

TABLE 2
Average path lengths from each component

| | C0 | C1∪2 | C3 | C4 | C5 | C6 | C7 | C8 | C9∪10 | C11 | C12 | Average |
|---|---|---|---|---|---|---|---|---|---|---|---|---|
| C0 | 0 | 1 | 1 | 1 | 1 | 1 | 2 | 2 | 2 | 2 | 3 | 1.5 |
| C1∪2 | 1 | 0 | 2 | 2 | 2 | 2 | 3 | 3 | 3 | 3 | 4 | 2.3 |
| C3 | 1 | 2 | 0 | 2 | 2 | 2 | 3 | 3 | 3 | 3 | 4 | 2.3 |
| C4 | 1 | 2 | 2 | 0 | 2 | 2 | 1 | 1 | 1 | 3 | 2 | 1.5 |
| C5 | 1 | 2 | 2 | 2 | 0 | 2 | 3 | 3 | 3 | 1 | 4 | 2.1 |
| C6 | 1 | 2 | 2 | 2 | 2 | 0 | 3 | 3 | 3 | 3 | 4 | 2.3 |
| C7 | 2 | 3 | 3 | 1 | 3 | 3 | 0 | 1 | 2 | 4 | 1 | 2.1 |
| C8 | 2 | 3 | 3 | 1 | 3 | 3 | 1 | 0 | 2 | 4 | 2 | 2.2 |
| C9∪10 | 2 | 3 | 3 | 1 | 3 | 3 | 2 | 2 | 0 | 4 | 3 | 2.4 |
| C11 | 2 | 3 | 3 | 3 | 1 | 3 | 4 | 4 | 4 | 0 | 5 | 2.9 |
| C12 | 3 | 4 | 4 | 2 | 4 | 4 | 1 | 2 | 3 | 5 | 0 | 2.9 |

In Table 2 the hops from each duster to the next duster have been counted, i.e. connection nodes have been ignored. Using the average length as the measure would result in either cluster C0 or cluster C4 being chosen as the root. Since both dusters have an identical average path length, it is immaterial which one is chosen and for the purposes of the following discussion duster C0 is chosen as the root or core cluster. Given this choice of root cluster, the tree links can be ordered to introduce the concept of moving towards and away from the core, as illustrated in FIG. 6 to provide a hierarchical tree structure.

As shown in FIG. 6, the network core is shown as duster C0 connected to the other clusters via connecting nodes. As explained, there is still the possibility that the “wrong” root could be chosen using this method. Therefore, the demand optimizer highlights the router(s) that it “thinks” constitutes the core cluster C0. If this is incorrect, then the demand optimizer provides a mechanism for the user to select an alternative router. The cluster containing this router could then be treated as the core cluster.

With a hierarchical tree structure having been imposed on the network (in a virtual sense, since, obviously, the actual network has not been affected), the demand optimization process can now take place. The strategy is, simply put, to decompose demands that span across more than one cluster in the network with a multiplicity of others that each span a single cluster. Furthermore, the solution should deal with the situation where multiple clusters need to be traversed before the core is reached. An optimization should be performed for each of these dusters, as there will now be multiple paths across (some of) these clusters. Before describing this optimization process in detail it should be noted that:
All rooted (i.e. hierarchical) trees will have a cluster at the core (root) and clusters at the leaves, with adjacent clusters being separated from each other by connection nodes;
There is a unique path across the duster tree for each demand from the ingress to the egress;
A singleton demand has identical ingress and egress nodes in the cluster tree;
A demand is local if the path for the demand has length 1, and otherwise is non-local. The length is allowed to be zero for the degenerate case of a singleton demand at a connection node;
The ingress cluster of a demand is the first cluster in the path;
The egress cluster is the last duster in this path;
A demand traverses a duster C if the duster is in the path for the demand and is neither the Ingress or egress cluster;
Associated with every cluster C is a set of demands whose path includes cluster C. Every cluster also has a set of child clusters, possibly empty. These are the descendants of cluster C in the tree connected to cluster C via a single connection node;

If will be apparent that if all the demands associated with a duster are local to the cluster then the muting of these demands can easily be optimized, by the demand optimizer, across the cluster without considering any other clusters. Where demands are encountered that are not local, the strategy taken is to decompose them into two demands, one of which is local and the other of which starts or finishes higher in the hierarchical cluster tree. By repeatedly applying this process, all the demands will eventually become local demands of some duster. More precisely, a non-local demand is “lifted” up to the lowest common ancestor of the ingress and egress clusters in the hierarchical cluster tree.

The complicating factor in this process is the QoS constraints attached to each demand. These define the acceptable paths for the demand. When a demand is decomposed into one that starts or finishes higher in the tree, new QoS constraints must be calculated that take into account the cost of reaching the new endpoint from the original one. If all nodes within a cluster are linked together in a tree fashion, then this could be done in a single step because the paths though such clusters are unique, and so it is trivial to compute the cost of traversing these paths. But in the more general case there may be multiple paths though each cluster, and this raises the question of which cost should be used.

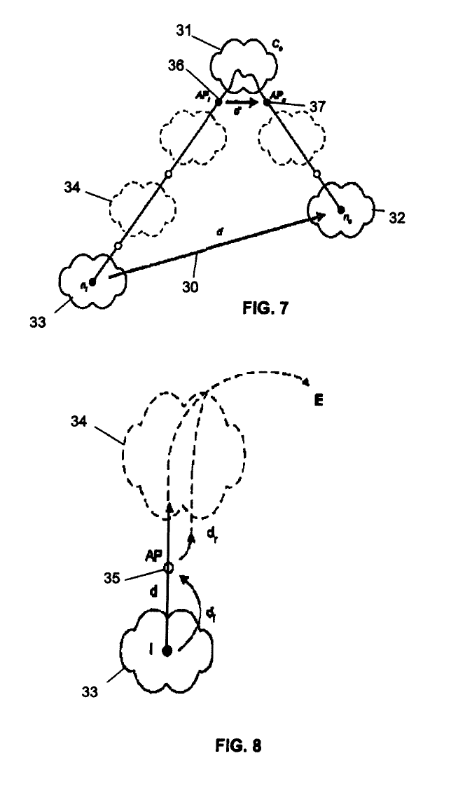

An example is illustrated in FIG. 7, where the lowest common ancestor of a demand d, with ingress node nᵢ and egress node nₑ, is the cluster 33 (Cₐ). Thus, as can be seen, there is a unique sequence of clusters that must be traversed by the demand from the ingress node nᵢ in cluster 33, in order to reach cluster 31 (Cₐ). There will, of course, be another sequence of dusters that must be traversed to reach the ingress node nᵢ in cluster 32, from duster 31 (Cₐ). Furthermore, the path from node nᵢ to cluster 31 (Cₐ) will enter duster 31 (Cₐ) via some connection node 36, (APₑ) and leave cluster 31 (Cₐ) via another connection node 37 (APᵢ). It will be apparent that these two connection nodes 36 and 37 must be different, since it they were identical then the cluster forming the left child of cluster 36 would be the lowest common ancestor and not duster 31 itself. Original demand 30 (d) is shown between clusters 33 and 32.

Thus, in order to optimise the demand 30, it is considered in duster 33 and split into a local (Intra-duster) demand and an inter duster demand. The process of splitting demands is further described with reference to FIG. 8, which shows the demand splitting process of an ingress cluster. Although the demands can be split at either or both the ingress and egress clusters, the process will be described further with respect to the ingress cluster only.

Thus, the demand d originating at ingress node nᵢ in duster 33 can be split into two sub-demands, being a local demand dₗ and the remainder, being an inter-cluster demand dᵣ. The local demand dₗ can then be optimised, together with all other intra-duster demands in cluster 33, and inter-duster demand dᵣ is passed up to the next cluster 34 in the tree. Of course, the original demand d has a QoS constraint associated with it. This might constrain the total delay permissible along any path used to carry traffic for demand d. Clearly such a limit has to be split between sub-demand dᵣ and sub-demand dₗ. The more freedom given to the routing across demand dₗ the less would be available for routing sub-demand dᵣ, and vice versa. If there is a unique path from ingress node nᵢ in duster 33 to the connection node 35 between cluster 33 and duster 34 then there is no choice. The cost for original demand d is fixed by this path, and so this can just be subtracted from the original cost to determine the QoS constraint to use for demand dᵣ. However, in the more general case, there will be many ways of splitting the QoS constraints. The strategy taken by the demand replacement and optimization process can be to first solve an optimization problem for the cluster 33 containing ingress node nᵢ. Preferential treatment may be given to demands such as sub-demand dₗ to increase the likelihood they will be allocated the shortest possible routes through cluster 33. Once a path is assigned to sub-demand dₗ, this can be used to compute the remaining QoS quota for the sub-demand dᵣ. A similar strategy can be used when the directions are reversed and the egress cluster is being processed for original demand d. Having determined the QoS constraint required for sub-demand dᵣ its placement can then be delegated to the parent duster 33. Once the whole tree has been optimised the paths chosen for sub-demand dₗ and sub-demand dᵣ can be used to determine the path to use for original demand d.

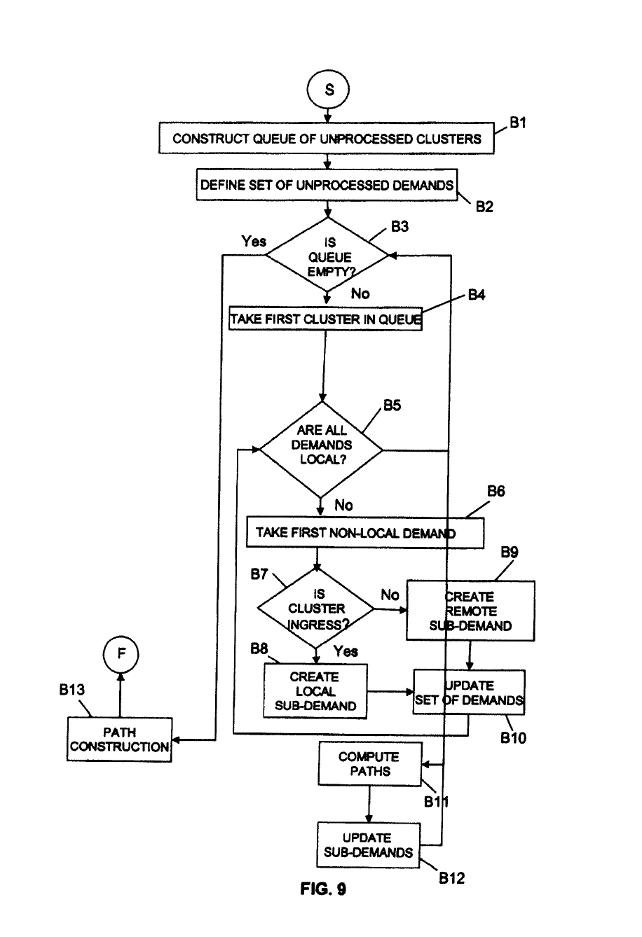

It can be seen, therefore, that a demand d will either be assigned a set of paths, in the case of a local demand, or a pair of sub-demands (dₗ, dᵣ) otherwise. The purpose of the demand replacement and optimization process is to set the local demands or sub-demands in a way that satisfies the QoS constraints of the demands. This will now be more fully described with reference to FIG. 9. It should be mentioned, however, that it may not be sufficient to just assign a set of paths to a demand; how much of the bandwidth should be allocated to each of the paths also needs to be known. However, for ease of exposition this detail is ignored in what follows.

FIG. 9 shows a flow diagram describing the elements of the demand replacement and optimization process. The purpose of the demand replacement and optimization process is to define paths for all the demands in the system. A local demand will be allocated one or more paths during the optimization of a duster. In the case of a non-local demand the association with paths is implicitly defined by the sub-demands dₗ, dᵣ. Initially all the demands will be unprocessed. Each cluster will therefore be processed until the queue is empty. In other words if a demand is not local then it must leave or enter a cluster via the unique parent connection node for that cluster.

The demand replacement and optimization process is accomplished by the following elements, with reference to FIG. 9, starting at element S:

B1: Construct queue. Construct queue Q of all clusters to be processed by performing a post-order traversal of the duster tree, skipping the connection nodes. The post-order traversal is an algorithm for exploring a trees structure that visits every cluster in the tree after visiting Its children.
B2: Define Set. Construct set υ to be the set of all unprocessed demands.
B3: Is Q empty? The Queue is then checked to see if it has any unprocessed dusters. If Q is not empty continue to B4. If it is empty then continue to B14
B4: Take first Cluster in Queue. The first duster In the queue is taken for Processing and the process moves on to B5

### B5: Are all Demands local? Are all the demands in the duster being processed local? If so, go to B11. If not, there must be a parent connection node for the duster and move to step B6.

B6: Take First Non-local Demand. The first non-local demand is taken for Processing and the process moves on to B7
B7: Is Cluster Egress? The duster being processed is either an ingress cluster or an egress duster for the non-local demand being considered. If it is an ingress cluster, the process moves to B8; if not, to B9.
B8: Create Local Sub-Demand. If it is an ingress duster then a new local sub-demand dₗ from ingress node nₗ to parent connection node is created and the process moves to B10.
B9: Create remote sub-Demand. If it is not an ingress cluster, then a new remote sub-demand dᵣ from parent connection node to egress node nₑ is created and the process moves to B10. An entry is made In the map of the new sub-demands. When adding a new entry to a map it is important to remove any existing entry from the map with the same key.
B10: Update Set. The Set υ of demands to be processed is updated by the deletion of the demand that has just been split into to, and the new remote sub-demand, i.e. the inter-cluster sub-demand is added to the set. The process then returns to B5 to check whether there are any more non-local demands to be processed.
B11: Compute set of paths. At this point all the demands in the cluster being processed are local, so a set of paths can be computed for each of them. In the general case, an optimization problem needs to be solved. The routing cost of the local demands needs to be minimised, to give the corresponding continuing sub-demands the maximum routing freedom. A path-based optimization strategy is now used and is started by assigning the shortest “weight” path (or paths), to the local demands, and a more complete set of paths to the remaining demands. Where a single attribute is considered, such as hop count, this means the paths are being applied in terms of the shortest path length. If the weight were cost, then the paths would be applied by the smallest cost. If all demands cannot be satisfied, then the set of paths needs to be widened and the demand replacement and optimization process is repeated. If the demand replacement and optimization process allows multiple paths to be assigned to a demand then flexibility is limited to the non-local demands. If a demand cannot be satisfied, for example because the QoS metric is too restrictive, then the set of paths will be empty.
B12: Update Remote Sub-demands. The remote (non-local) sub-demands that were created in B9 are now updated with the same properties as the original demand, except that the QoS constraint is reduced by the weight of the path allocated to the corresponding local sub-demand dₗ. The process then moves back to B3 to check whether there are any more unprocessed clusters.
B13: Path Construction. If all the dusters have been processed, i.e. the queue is empty, the process moves to B13. Since all demands have now been optimised, paths can be constructed for all demands through all the dusters.

It will be appreciated that the demand replacement and optimization process, as described above, is possibly more sequential than it needs to be. Instead of a queue, a cluster could be processed in parallel with other clusters in the cluster tree.

Ideally demands should be aggregated with common properties as the demand replacement and optimization process moves up the duster tree. For example, when a demand is added to the parent duster, there may already be a demand going to the same destination (or coming from the same origin), with a compatible traffic class. In this case, the bandwidth requirement of the existing demand may just need to be increased, rather than adding the second demand. The order in which dusters are processed may also affect the potential for such aggregation. It is conjectured that traversal orders that attempt to optimize tunnel production may also increase the likelihood of demand aggregation.

Many network operators split the management of the network across multiple organisational boundaries. It is important to align the clusters with each organisation, so the demand replacement and optimization process does not attempt to optimize a collection of routers under the control of multiple organisational groups. Note that this does not imply only as many clusters should be constructed as there are organisational entities, but that it must be ensured that no clusters are split across such entities.

Cluster merging has been discussed earlier, and cluster splitting has discussed above. Given a predefined grouping of routers there will be a need to automate the merging and splitting of dusters identified by the bi-connected cluster analysis, so the resulting clusters respect this grouping. The demand replacement and optimization algorithm of the above embodiment attempts to place all the demands. However, when the network is partitioned along administrative boundaries, this approach may need to be refined.

For example, suppose the access network is being managed by an access group. The access group would execute the demand replacement and optimization process until the demands were lifted to the core cluster(s). The resulting demands would be presented to the core group as a set of requirements. These would eventually be satisfied by a set of LSPs which would then be fed back into the demand replacement and optimization process which could then complete the provisioning, or placement, of the access LSPs. In some scenarios, such as the VoIP gateway case, it may be acceptable for these core demand requirements to be satisfied by a collection of LSPs, to spread the load.

Thus, as explained above various algorithms can be used to decompose network topologies in a way that simplifies the optimization of demand placement. Access trees are simple to identify, and in some cases may be sufficient to yield a tractable problem. An approach based on the identification of bi-connected clusters was developed for those examples where the access elements of the network are more complex in structure. The optimization process is more involved in this case, but allows a far richer collection of networks to be tackled. To align the dusters with administrative boundaries, and to split individual components that are still too large to optimize as a whole, virtual connecting nodes were introduced. Of course there may be some networks where none of these techniques will be sufficient.

The optimization strategy described above, is based upon exploiting bottleneck nodes, either naturally occurring in the network, or artificially created to help the decomposition process. There is an obvious conflict here, as bottlenecks are undesirable from a path-protection standpoint. Multiple nodes may need to be grouped and links into virtual nodes, allowing redundancy at the physical level whilst looking like a single object to the demand optimization and replacement process. The hierarchical structure may be able to be used to simplify the path restoration problem as well.

Whilst the introduction of virtual network nodes may allow a multi-access network to be de-coupled from the network core, it complicates any post-optimization processing, for example, where a demand originating in the multi-access network is replaced by a demand originating at the network node. If the multi-access network has multiple entry points into the core, then the network node will end up being treated as part of the core during the optimization process. The demand replacement and optimization process will compute one or more paths to carry the demand originating at the network node. But this node doesn't really exist, so these paths cannot simply be mapped to LSPs. The first hop in each of these paths will be to a real router within the core, and so this router can be used as the egress for the LSP associated with the path. The original demands would tunnel through these LSPs, just as In the point-to-point case.

The embodiment described above provides a solution to the problem of optimizing demands, specifically for complex access networks. The apparatus and method of the embodiment is able to infer from these demands a set of requirements for LSPs crossing the core. Having optimized the core LSPs then these can be used to route the access LSPs.

It will be appreciated that although only one particular embodiment of the invention has been described in detail, various modifications and improvements can be made by a person sidled in the art without departing from the scope of the present invention.

1. A method of optimizing routing of demands in a network comprising nodes interconnected by links, each demand comprising a source node, a destination node and at least one demand parameter requirement, the method comprising:
a) partitioning nodes and links of a network into a set of clusters of links and nodes;
b) imposing a hierarchical tree structure on the set of clusters such that any pair of clusters has a unique path between them via a closest common ancestor;
c) determining optimum paths for all demands such that the paths meet the at least one demand parameter requirement by processing the demands in each cluster only after all descendent clusters in the hierarchical tree structure have been processed, the processing for each cluster comprising:
i. splitting each demand into an intra-cluster demand in which the source and destination nodes are in the same cluster and, if appropriate, an inter-cluster demand in which the source and destination nodes are in different clusters;
ii. determining optimum paths for all intra-cluster demands so as to meet the at least one demand parameter requirement; and
iii. passing all inter-cluster demands upwards to the next cluster in the hierarchical tree structure to be processed as a demand therein.

2. A method of optimizing routing of demands in a network according to claim 1, further comprising passing information relating to network costs of the paths that have already been optimized upwards to the next cluster in the hierarchical tree structure so that the network costs already used can be utilized when determining optimum paths for intra-cluster demands still to be optimized.

3. A method of optimizing routing of demands in a network according to claim 2, wherein the network costs comprise costs incurred with respect to a particular demand parameter requirement.

4. A method of optimizing routing of demands in a network according to claim 1, wherein the at least one demand parameter requirement comprises a maximum delay requirement.

5. A method of optimizing routing of demands in a network according to claim 1, wherein the at least one demand parameter requirement comprises a traffic class requirement.

6. A method of optimizing routing of demands in a network according to claim 1, wherein the determination of optimum paths for all demands includes determining optimum paths based on at least one network parameter requirement.

7. A method of optimizing routing of demands in a network according to claim 6, wherein the at least one network parameter requirement comprises a traffic density requirement.

8. A demand optimizer for optimizing routing of demands in a network comprising nodes interconnected by links, the demand optimizer comprising:
an input handler for receiving details of the network structure and demands to be optimized;
a memory for storing the details of the network structure and demands; and
a network structure analyser coupled to the memory configured to analyze the network by:
partitioning nodes and links of a network into a set of clusters of links and nodes;
imposing a hierarchical tree structure on the set of clusters such that any pair of clusters has a unique path between them via a closest common ancestor;
determining optimum paths for all demands such that the paths meet the at least one demand parameter requirement by processing the demands in each cluster only after all descendent clusters in the hierarchical tree structure have been processed, the processing for each cluster comprising:
splitting each demand into an intra-cluster demand in which the source and destination nodes are in the same cluster and, if appropriate, an inter-cluster demand in which the source and destination nodes are in different clusters;
determining optimum paths for all intra-cluster demands so as to meet the at least one demand Parameter requirement; and
passing all inter-cluster demands upwards to the next cluster in the hierarchical tree structure to be processed as a demand therein.
